(19) United States
(12) Patent Application Publication
(10) Pub. No.: US 2005/0160175 A1
(43) Pub. Date: Jul. 21, 2005

(54) Communication system employing HTTP as transfer protocol and employing XML documents to automatically configure VoIP device

(75) Inventor: Fu-Shen Ho, Hsinchu (TW)

Correspondence Address: BACON & THOMAS, PLLC, 625 SLATERS LANE, FOURTH FLOOR, ALEXANDRIA, VA, 22314, US

(73) Assignee: D-Link Corporation, Hsinchu (TW)

(21) Appl. No.: 10/760,368

(22) Filed: Jan. 21, 2004

(51) Int. Cl. G06F 15/16; H04L 12/66

(52) U.S. Cl. 709/228; 370/352; 455/435.1

(57) ABSTRACT

The present invention is to provide a communication system, which is adapted to employ a HTTP as a transfer protocol, and enables the VoIP device to issue required provision-request documents in XML syntax to a provisioning server of an ITSP over the Internet, the provisioning server then verifies the identification thereof. If the verification is true, the provisioning server retrieves setting parameters required to configure the VoIP device from a user database, stores the parameters in a provision-response package written in XML syntax, and sends the package back to the VoIP device. Then, the VoIP device performs a configuration on itself based on the parameters and proceeds with a registration to a call agent of the ITSP automatically.

### FIELD OF THE INVENTION

The present invention relates to VoIP (Voice Over IP (Internet Protocol)) device and more particularly to a communication system employing HTTP as transfer protocol and employing XML documents to automatically configure a VoIP device.

### BACKGROUND OF THE INVENTION

VoIP devices for household or small business are widely popular among consumers in recent years because a user can use the VoIP device to communicate with another person at a remote location over the Internet in a rate much lower than that of a typical long distance (including international) call. For keeping up with the trend and exploring the potential, vast market, many Internet telephony service providers (ITSPs) has begun to provide VoIP devices and related communication services to clients. As a result, many households and businesses can save much money in making long distance (including international) calls.

Typically, a number of parameters are required to set prior to using a VoIP device to make an online conversation via the existing VoIP device. These parameters comprise:
(i) IP address or DNS (Domain Name Server) name of call agent of ITSP, and/or default port number: A VoIP device is able to find a call agent of ITSP by means of IP address or DNS name, and communicate the same if found.

(ii) IP address of DNS: A VoIP device is able to find a DNS by means of IP address, and convert the same into a corresponding IP address by means of DNS name of the server.

(iii) Identifier of VoIP device (e.g., gateway domain name in MGCP endpoint identifier): A VoIP device is able to command a server to identify a user by means of its identifier rather than use IP address of VoIP device. Hence, a different IP address may be assigned to a VoIP device at any time.

(iv) Driver filename of VoIP device and FTP (File Transfer Protocol) server, or IP address of TFTP (Trivial File Transfer Protocol) server: A VoIP device is able to determine whether an upgrade of software version is required by referring to above information.

Thus, an ITSP has to perform one of two following methods to set or modify the above parameters in configuring the VoIP device.

(i) A management employee connects a port of computer to a RS-232 port on the VoIP device. Next, run a software installed in the computer to load a set screen of the VoIP device so as to set or modify the VoIP device. One drawback of such technique is that the management employee has to go to the location of the VoIP device for the setting or modification, resulting in a great consumption of time and labor.

(ii) The VoIP device provides a HTTP server (or Telnet server) so that a management employee is able to access the Internet by operating a computer at a remote site, and load a set screen of the VoIP device so as to set or modify the VoIP device by using a browser (or Telnet). Drawbacks of such technique are that the management employee has to know a correct IP address of each VoIP device prior to loading a set screen of the VoIP device. Also, one VoIP device cannot have an IP address the same as that of another VoIP device. This can cause great trouble to management employees. Moreover, in the above case of setting or modifying the VoIP device by a management employee by using browser, the management employee has to first find the IP address of a first VoIP device prior to loading a set screen for setting and exiting after the setting. Next, the management employee has to find the IP address of an immediate next VoIP device prior to loading a set screen for setting and exiting after the setting. This process will repeat until settings of all VoIP devices are finished. Hence, a management employee has to do the above actions for several thousand times (e.g., 3,000) if the number of the VoIP devices is, for example, 3,000. Also, a management employee has to repeat the above setting actions of related devices (including servers and terminals at users) for such number of times if there is any setting change. This is a very time consuming and labor intensive task.

Particularly, such can cause great trouble in setting, management, and maintenance for management employees because the number of VoIP device users is increased significantly (i.e., the number of VoIP devices is very large). Such manual setting is blamed for the prohibition of proliferation of VoIP device related services. For saving time and cost, it is preferred for network service providers to implement a mechanism to quickly, automatically set basic data of a VoIP device when a great number of VoIP devices are to be installed. Currently, there are three mechanisms employed to automatically set a VoIP device as below.

(i) Use SNMP (simple network management protocol) to access device settings, current states, and setting parameters from a server. However, SNMP is relatively complicated for VoIP devices. Also, it is inconvenient in use, low in future expansibility, and poor association between itself and user databases of servers.

(ii) Use DHCP (dynamic host configuration protocol) to access a dynamic Internet address and other settings from a server. DHCP is simple but it is poor to associate itself with user databases of servers. Further, following disadvantages have been found in automatically setting a VoIP device by DHCP. For example, definitions set by network service providers are different and also standards are different when DHCP is used to set vendor extension options other than address data. Further, different DHCPs are used in different OSs (operating systems). As such, much time and labor will be spent on transferring a feature of automatic setting dedicated to one system to another system in which settings and modifications are also performed.

(iii) Some VoIP devices use proprietary mechanisms of automatic setting for avoiding the above problems from occurring. However, a network service provider has to develop a novel server for automatic setting since there is no standard protocol to follow. Technology, time, and cost required for developing the novel server are too difficult to be contemplated by a single network service provider who provides a great number of VoIP devices to users.

Thus, it is desirable among designers, developers, and service providers of VoIP device to provide means capable of enabling a server to easily, quickly, and automatically set or modify settings of VoIP devices of users at geographically different locations, thereby carrying out an automatic setting and management of VoIP devices, significantly reducing labor and operating time, and reducing human errors to a minimum.

### SUMMARY OF THE INVENTION

A primary object of the present invention is to provide a communication system employing HTTP as a transfer protocol and employing XML documents to automatically configure VoIP device wherein in response to connecting to a VoIP device over the Internet, the system is adapted to employ the HTTP as a transfer protocol, and enables the VoIP device to issue required provision-request documents in XML syntax to a provisioning server of an ITSP over the Internet, the provisioning server then verifies the identification of the provision-request documents. If the verification is true, the provisioning server retrieves setting parameters required to configure the VoIP device thereafter from a user database, stores the configuration parameters in a provision-response package written in XML syntax, and sends the provision-response package back to the VoIP device. Then, the VoIP device performs a configuration on itself based on the sent back configuration parameters in response to receiving the provision-response package. After finishing the configuration, the VoIP device proceeds with a registration to a call agent of the ITSP automatically.

One object of the present invention is to provide a communication system employing HTTP as a transfer protocol and employing XML documents to automatically configure VoIP device. By utilizing the widely employed HTTP and XML tool of high compatibility and expansibility, the present invention can significantly reduce the development cost of VoIP device and error detection time, and increase convenience in future maintenance and upgrading.

Another object of the present invention is to enable the communication system to use one of two standard authentication techniques including Cleartext Password and Digest Authentication to verify a VoIP device with respect to messages transferred by using HTTP by the VoIP device so that it is possible of adding highly safe authentication and encryption mechanisms to HTTP without adversely affecting the existing functions, and providing a high transmissibility and compatibility with respect to firewall and NAT installed in a household or business.

The above and other objects, features and advantages of the present invention will become apparent from the following detailed description taken with the accompanying drawings.

### BRIEF DESCRIPTION OF THE DRAWINGS

FIG. 1 presents schematically the connection of a communication system according to the invention; and

FIG. 2 depicts the processing by the communication system according to the invention.

### DETAILED DESCRIPTION OF THE PREFERRED EMBODIMENTS

A HTTP (Hyper Text Transfer Protocol) is one of many protocols used over the Internet. By utilizing HTTP, an electronic device at a user end is able to retrieve a hyper text file from a server over the Internet by using a browser provided in the electronic device. As to XML (Extensible Markup Language), it is a hierarchical electronic document. As compared with a similar HTML (Hyper Text Markup Language), XML is more flexible and is adapted to add new functions. HTTP is the standard protocol currently used over the Internet and is widely used by various network communication equipment and related chips. XML is not only a standard but also has the capability of supporting the customization of documents. Also, software associated with XML is easy to run. Thus, XML has been widely used in browsers and other related software packages. Hence, such software is able to run in different operating platforms.

In view of the above, the invention is able to employ the HTTP as a transfer protocol, and write required provision-request documents and provision-response documents in XML syntax. Hence, a VoIP device is adapted to communicate with a provisioning server of an ITSP in a connection over the Internet, retrieve setting parameters required by the VoIP device from a user database of the provisioning server, and automatically configure the VoIP. As a result, setting and management problems as experienced by the prior VoIP device are eliminated.

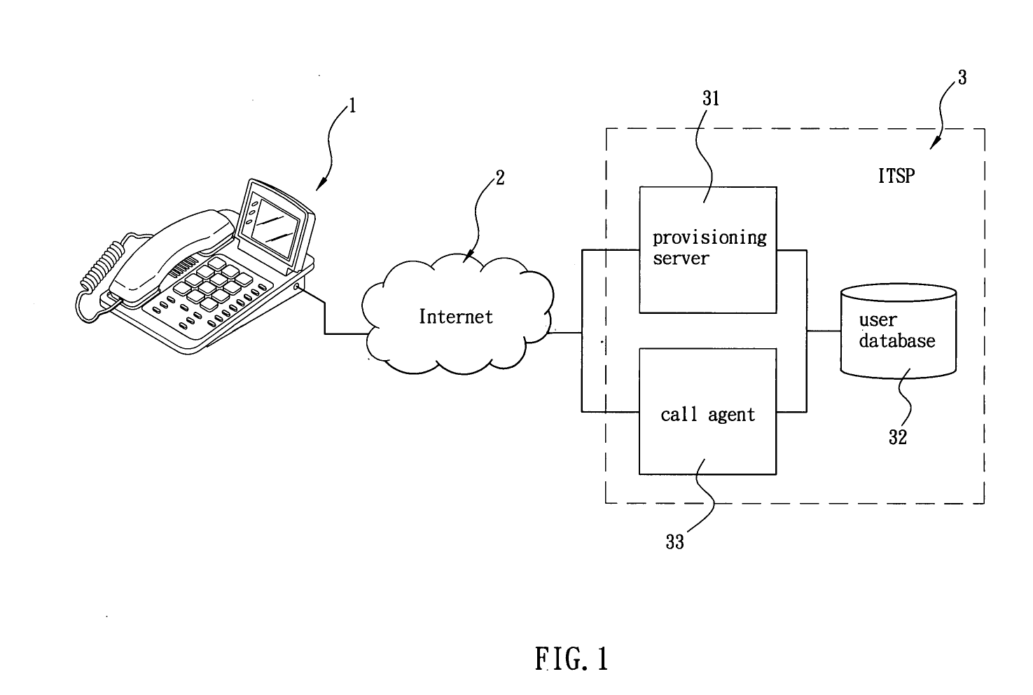

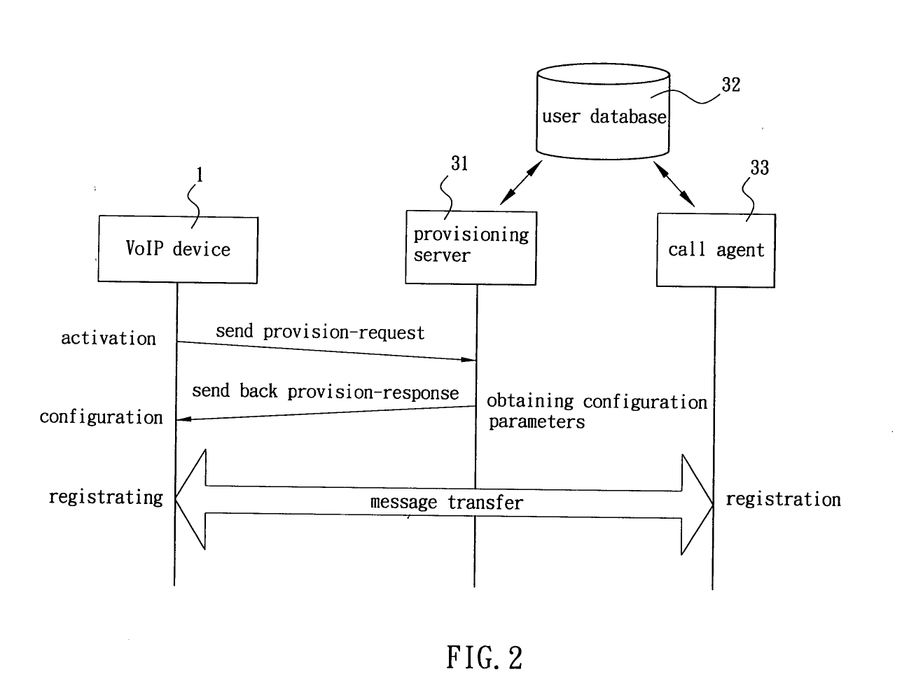

Referring to FIG. 1, there is shown a preferred embodiment of the invention. As shown, a connection is established between a VoIP device 1 and a provisioning server 31 of an ITSP 3 over the Internet 2. Referring to FIG. 2, in a case of the VoIP device 1 activated, the VoIP device 1 uses the HTTP as a transfer protocol to issue a provision-request package and send the same to the provisioning server 31 over the Internet 2. The provisioning server 31 then verifies the identification of the provision-request package in response to receiving the same. If the verification is true, the provisioning server 31 then reads parameters from a user database 32 of the provisioning server 31 required to configure the VoIP device 1 thereafter, stores the configuration parameters in a provision-response package, and sends the provision-response package back to the VoIP device 1. Next, the VoIP device 1 performs a configuration on itself based on the sent back configuration parameters in response to receiving the provision-response package. After finishing the configuration, registration and related processing with respect to the VoIP device 1 are done by a call agent 33 of the ITSP 3. In such a manner, the automatic configuration of the VoIP device 1 can be carried out. As an end, a user is able to make a call with a remote party over the Internet.

In the preferred embodiment, a document of provision-request package is hypertext written in GET request commands of HTTP and XML syntax. Contents of the document is as follows:

TCP Header

HTTP/1.1 GET/provision/request.xml
Content Type: text/xml
Content-Length: 368
<?xml ‘version= ‘1.0’ standalone = ‘no’ ?>
<request>

<header>

<name>VoIPDevice</name>
<version>1.00B01</version>

</header>
<msgbody>

<devinfo>

<hwaddress>00:50:ba:01:02:03</hwaddress>
<ipaddress>10.1.2.3</ipaddress>

</devinfo>

</msgbody>

</request>

The document of provision-request is written in the following XML syntax and elements for requesting the provisioning server 31 to send parameters required to configure the VoIP device 1 thereto:
(i) <request>: It means the document is a provision-request. However, the invention is not limited to such in practice. To the contrary, all similar elements in XML syntax (e.g., <response>, <statistics>, <notify>, etc.) capable of achieving the same purpose are within the scope of the invention.
(ii) <header>: It is adapted to store general information including XML versions, product descriptions, and customer numbers.
(iii) <msgbody>: It represents main contents of information. The main contents are adapted to modify depending on applications.
(iv) <devinfo>: It is adapted to store information including serial numbers, MAC (media access control) addresses, and IP addresses related to identify the VoIP device.

Note that the invention is not limited to such in practice. Rather, it is possible of increasing or decreasing XML syntax elements, access techniques, and relevant information depending on applications in any other embodiments of the invention.

The provisioning server 31 may use authentication of HTTP to verify the provision-request in response to receiving the provision-request package. Next, find profile of a user from the user database 32. A provision-response package is then issued and sent back to the VoIP device 1 if the provision-request is verified to come from an authorized user. Otherwise, the provisioning server 31 sends an unauthorized error code number 401 or a forbidden error code number 403 to the VoIP device 1 based on HTTP.

In the preferred embodiment, a document of provision-response package is written similar to that of provision-request package. That is, the document of provision-response package is hypertext written in GET request commands of HTTP and XML syntax. Contents of the document is as follows:

TCP Header

HTTP/1.1 200 ok
Content Type: text/xml
Content-Length: 600
<?xml version= ‘1.0’ standalone = ‘no’ ?>
<response>

<header>

<name>VoIPDevice</name>
<version>1.00B01</version>

</header>
<msgbody>

<devinfo>

<hwaddress>00:50:ba:01:02:03</hwaddress>
<ipaddress>10.1.2.3</ipaddress>

</devinfo>
<parameters>

<domain>voip.dlink.com.tw</domain>
<callagent>10.4.5.6</ callagent>
<callagentport>2427</ callagentport>
<devname>voip01</devname>
<ftpsrv>10.33.44.55</ftpsrv>
<fwname>/download/voip/voipdev_fw.100b01</fwname>

</parameters>

</msgbody>

</response>

In view of the above document, the provisioning server 31 will reply a HTTP confirmation message with code number 200 in response to verifying the received provision-request package to be true. Next, the provisioning server 31 carries an XML document of provision-response. The document of provision-response is similar to that of provision-request except that a set of XML elements representing setting parameters of VoIP device are added. In the case of the protocol of MGCP (RFC2705), setting parameters of the provision-response essentially comprise the following items:
(i) <domain>: It represents domain, i.e., service scope.
(ii) <callagent>: It represents an address of the call agent 33 of the VoIP device 1. Such address can be either an IP address or FQDN (fully qualified domain name).
(iii) <callagentport>: It represents a communication port of the call agent 33 of the VoIP device 1.
(iv) <devname>: It represents name of the VoIP device 1.

Note that the invention is not limited to such in practice. Rather, it is possible of storing the following items in the document of provision-response if firmware updating of the VoIP device 1 is desired:
(i) <ftpsrv>: It represents an address of FTP server. The address can be an IP address, FQDN, or more than one. Other techniques such as utilizing setting parameters <tftpsrv> in TFTP, and utilizing setting parameters <fwhttpsrv> in HTTP are available for updating firmware.
(ii) <fwname>: It represents a path name of firmware file of server.

An automatic configuration of the VoIP device 1 can be carried out by itself based on the sent back setting parameters in response to receiving the provision-response package. After finishing the configuration, registration and related processing with respect to the VoIP device 1 are done by a call agent 33 of the ITSP 3 based on addresses and communication ports of the call agent 33 described in the setting parameters. In such a manner, the automatic configuration of the VoIP device 1 can be carried out. As an end, a user is able to make a call with a remote party over the Internet 2.

The communication system of the invention thus has the following functions and features after performing the above automatic configuration:

(i) Reduction of development cost and error detection time. In the above automatic configuration, system compatibility and future expansibility are higher than that of other protocols since the used protocol, as the standard protocol over the Internet 2, has been widely used by various network communication equipment and related chips. By utilizing HTTP and XML tool, the invention can significantly reduce the development cost of VoIP device and error detection time.

(ii) Reduction of development time of server and increase of convenience in future maintenance and upgrading. It is known that both the widely used HTTP servers and database systems (e.g., Oracle, DB2, and Microsoft SQL Server) support XML document conversion. It is thus possible of significantly reducing development time of server and increasing convenience in future maintenance and upgrading by utilizing the powerful expansibility and readability of XML.

(iii) Use two standard authentication techniques for verification. The invention uses either Cleartext Password or Digest Authentication to verify a VoIP device with respect to messages transferred by using HTTP by the VoIP device.

(iv) Adding highly safe authentication and encryption mechanisms. As stated above, a VoIP device of the invention uses HTTP to transfer messages. Hence, it is possible of adding highly safe authentication and encryption mechanisms (e.g., SSLv3, TLSv1.0, etc.) to HTTP without adversely affecting the existing functions. As a result, it is possible of upgrading HTTP as the type of protocol HTTPS for providing a more safe data transfer.

(v) High transmissibility and compatibility with respect to firewall and NAT (network address translation). The invention has a high transmissibility and compatibility with respect to firewall and NAT installed in a household or business by using HTTP. This feature is not achievable by any prior art methods.

While the invention has been described by means of specific embodiments, numerous modifications and variations could be made thereto by those skilled in the art without departing from the scope and spirit of the invention set forth in the claims.

1. A communication system comprising employing HTTP as a transfer protocol; writing required provision-request documents and provision-response documents in XML syntax; enabling a VoIP device to communicate with a provisioning server of an ITSP in a connection over the Internet, retrieving setting parameters required by the VoIP device from a user database of the provisioning server, and automatically configuring the VoIP.

2. The communication system of claim 1, wherein in response to activating the VoIP device, the VoIP device uses the HTTP as a transfer protocol to issue a provision-request package and send the same to the provisioning server over the Internet so that the provisioning server verifies the identification of the provision request package in response to receiving the provision-request package, and if the verification is true, reads parameters from the user database of the provisioning server required to configure the VoIP device, stores the configuration parameters in a provision-response package, and sends the provision-response package back to the VoIP device, and the VoIP device performs a configuration on itself based on the sent back configuration parameters in response to receiving the provision-response package.

3. The communication system of claim 2, wherein after finishing the configuration, registration and related processing with respect to the VoIP device are done by a call agent of the ITSP.

4. The communication system of claim 3, wherein a document of the provision-request package is hypertext written in GET request commands of HTTP and XML syntax, and contents of the document of the provision-request package comprises:
request means for representing the document being a provision-request;
header means for storing general information including XML versions, product descriptions, and customer numbers;
message body means for representing main contents of information; and
device information means for storing information including serial numbers, MAC addresses, and IP addresses related to identify the VoIP device.

5. The communication system of claim 3, wherein a document of the provision-response package is hypertext written in GET request commands of HTTP and XML syntax, and contents of the document of the provision-response package comprises:
request means for representing the document being a provision-request;
header means for storing general information including XML versions, product descriptions, and customer numbers;
message body means for representing main contents of information; and
device information means for storing information including serial numbers, MAC addresses, and IP addresses related to identify the VoIP device.

6. The communication system of claim 5, wherein the contents of the document of the provision-response package further comprises:
domain means for representing a service scope;
means for representing an address of the call agent, the address being either an IP address or FQDN;
means for representing a communication port of the call agent; and
means for representing a name of the VoIP device.

7. The communication system of claim 6, wherein the contents of the document of the provision-response package further comprises:
means for representing an address of FTP, TFTP, or HTTP server, the address being either an IP address or FQDN; and
means for representing a name of a firmware file of the server.
